(19) United States
(12) Patent Application Publication
(10) Pub. No.: US 2026/0148907 A1
(43) Pub. Date: May 28, 2026

(54) SWITCH DEVICE

(71) Applicant: KABUSHIKI KAISHA TOKAI RIKA DENKI SEISAKUSHO, Aichi (JP)

(72) Inventors: Takao IMAI, Aichi (JP); Masanori FUJII, Aichi (JP); Itaru WATANABE, Aichi (JP); Kazuo DODOMEKI, Aichi (JP); Masayoshi AMANO, Aichi (JP); Kenta YAMAMOTO, Aichi (JP)

(73) Assignee: KABUSHIKI KAISHA TOKAI RIKA DENKI SEISAKUSHO, Aichi (JP)

(21) Appl. No.: 19/177,718

(22) Filed: Apr. 14, 2025

(30) Foreign Application Priority Data
Apr. 22, 2024 (JP) 2024-069112

(51) Int. Cl. H01H 13/14; H01H 13/02

(52) U.S. Cl. CPC H01H 13/14; H01H 13/023

(57) ABSTRACT

A switch device includes a panel, movable members, a detector, and a sensor sheet. The panel includes operating portions that receive a push-operation. Each movable member is moved by the push-operation performed on a corresponding operating portion. The detector detects movement of the movable members. The sensor sheet is arranged between the panel and the movable members to detect at least one of contact of a human body part with the panel, approach of a human body part toward the panel, and the push-operation performed on the panel. The sensor sheet includes a sheet base configured to be bent and deformed, and electrodes each arranged on the base sheet for a corresponding operating portion. The sheet base includes a gap formed between adjacent ones of the electrodes. The electrodes each include a wiring part, and wiring parts of at least two of the electrodes are connected to one another other.

### CROSS-REFERENCE TO RELATED APPLICATIONS

This application is based upon and claims the benefit of priority from Japanese Patent Application No. 2024-069112, filed on Apr. 22, 2024, the entire contents of which are incorporated herein by reference.

### BACKGROUND

### 1. Field

The following description relates to a switch device that detects a push-operation performed on a panel.

### 2. Description of Related Art

Japanese Laid-Open Patent Publication No. 2013-134635 discloses a typical operation switch device that detects both a touch-operation and a push-operation. In the operation switch device, a touch detection electrode detects a touch-operation when a user touches an operation region of an operation member of an operation switch unit with a finger. If the operation region is further depressed with the finger, the operation region is moved and changes a state of a push switch located at the depression destination of the operation region. In this case, a push-operation is detected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

With the above operation switch device, a touch-operation performed on the operation member with a finger is detected by the touch detection electrode arranged on a back surface of the push switch. Therefore, the given distance between the operation member and the touch detection electrode may adversely affect the touch-operation detection sensitivity. In this case, for example, separate touch detection electrodes may be arranged on a back surface of the operation member for respective operation regions to allow touching of the operation member to be detected using the touch detection electrodes arranged near the operation member. However, this arrangement reduces the size of each touch detection electrode such that detection sensitivity will not increase.

In order to increase the touch-operation detection sensitivity, for example, a single large touch detection electrode may be arranged on the back surface of the operation member to be shared across multiple operation regions. Nonetheless, for example, when a certain operation region of the operation member is pushed, the load may be applied to only the pushed portion of the touch detection electrode. This may result in breakage of the touch detection electrode at the portion that received the load.

In one general aspect, a switch device includes an elastically deformable panel, movable members, a detector, and a sensor sheet. The panel includes operating portions. Each of the operating portions is configured to receive a push-operation and assigned to a corresponding one of operation functions. The movable members are each configured to be moved by the push-operation performed on a corresponding one of the operating portions. The detector is configured to detect movement of the movable members moved by the push-operation. The sensor sheet is arranged between the panel and the movable members to detect at least one of contact of a human body part with the panel, approach of a human body part toward the panel, and the push-operation performed on the panel. The sensor sheet includes a sheet base configured to be bent and deformed, and electrodes each arranged on the base sheet for a corresponding one of the operating portions. The sheet base includes a gap formed between adjacent ones of the electrodes. The electrodes each include a wiring part, and wiring parts of at least two of the electrodes are connected to one another other.

Other features and aspects will be apparent from the following detailed description, the drawings, and the claims.

### BRIEF DESCRIPTION OF THE DRAWINGS

FIG. 1 is a front view of a switch device in accordance with an embodiment.

FIGS. 2A, 2B, and 2C are diagrams illustrating a push-operation performed on a panel.

FIG. 3 is a longitudinal cross-sectional view of the switch device.

FIG. 4 is an enlarged view of part of the longitudinal cross-section of the switch device.

FIG. 5 is a perspective view of a sensor sheet fitted to a casing.

FIG. 6 is a diagram of the sensor sheet in an unfolded state.

FIG. 7A is a diagram of a state before the panel is pushed.

FIG. 7B is a diagram of a state in which the panel is pushed.

FIG. 8 is a diagram showing the electrical configuration of the switch device.

FIG. 9 is a diagram illustrating the operation of the sensor sheet.

FIG. 10 is a perspective view showing a modified example of the sensor sheet.

FIG. 11A is a diagram of a state before the panel is pushed.

FIG. 11B is a diagram of a state in which the panel is pushed.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of the present disclosure will now be described.

### Switch Device 1

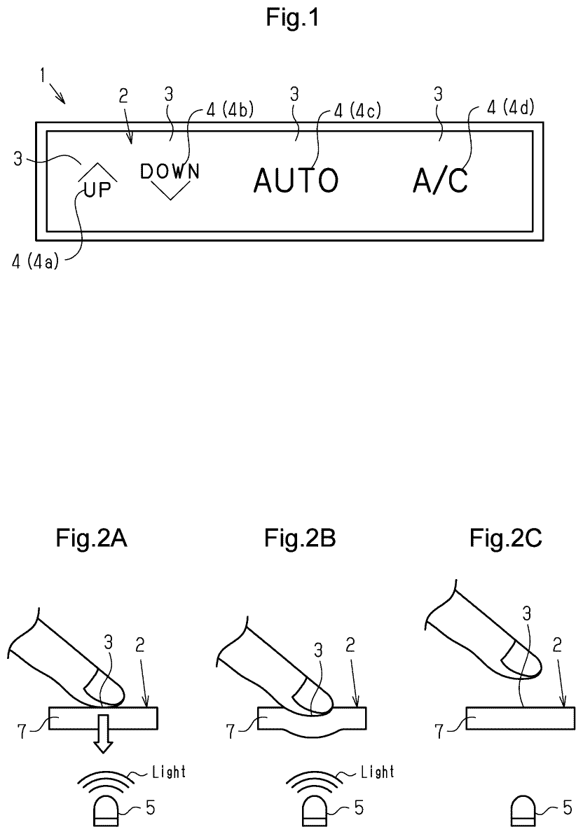

As shown in FIG. 1, a switch device 1 includes a panel 2 that is operated by a user to switch a state of an apparatus, or set a function of the apparatus. The apparatus includes, for example, a vehicle-on-board air conditioner. In the case of the air conditioner, switching of the state of the apparatus (setting of the function of the apparatus) includes, for example, changing of the temperature, switching of the on-off state of an automatic mode, switching of the on-off state of an A/C mode, changing of an air blowing mode, or the like.

The panel 2 includes a front surface on which operating portions 3 are respectively assigned to operation functions. That is, the panel 2 includes the operating portions 3. Each of the operating portions 3 is assigned to a corresponding one of the operation functions. In the present example, the front surface of the panel 2 is divided into multiple operating portions 3. The operation functions include, for example, a temperature changing function, an automatic mode on-off function, an A/C mode on-off function, or the like. The operating portions 3 include, for example, a temperature increasing portion 3, a temperature decreasing portion 3, an automatic mode on/off switching portion 3, an A/C mode on/off switching portion 3, or the like.

As shown in FIGS. 2A to 2C, the panel 2 is a touch panel of a push-in type. Each operating portion 3 is configured to be touched by the user with a finger or the like, and pushed by a predetermined amount. Specifically, as shown in FIGS. 2A and 2B, the user may touch a certain operating portion 3 on the panel 2 and push the operating portion 3 by the predetermined amount. This operates the apparatus in accordance with the pushed operating portion 3. As shown in FIG. 2C, when the finger is removed from the operating portion 3 following the push-operation, the panel 2 elastically deforms and returns the operating portion 3 to the original state.

In the present example, for example, a mark 4 is displayed on the panel 2 when a body part of the user touches or approaches the front surface of the panel 2. The mark 4 is provided for a corresponding one of the operating portions 3 (refer to FIG. 1). Specifically, when the front surface of the panel 2 is not touched, no mark 4 is displayed on the panel 2. When the front surface of the panel 2 (operating portion 3) is touched, the mark 4 is displayed by a light from a light source 5 arranged at a back-surface side of the panel 2. A touch-operation of the present example includes not only an operation in which the user directly touches the panel 2 with a body part, such as a finger or the like, but also an approach-operation in which, for example, the user holds a hand near the panel 2. The mark 4 includes, for example, a temperature increasing mark 4a, a temperature decreasing mark 4b, an automatic mode operation mark 4c, an A/C mode operation mark 4d, or the like.

### Panel 2

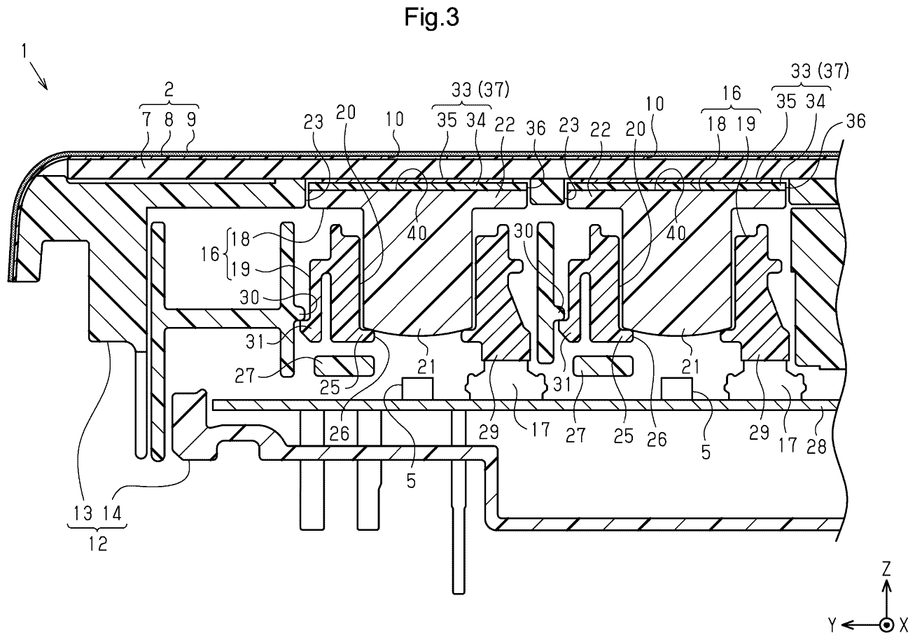

As shown in FIG. 3, the panel 2 is elastically deformable and includes the operating portions 3. The operating portions 3 each receive a push-operation and are respectively assigned to the operation functions. In the present example, the panel 2 includes a panel member 7, an intermediate layer 8, and a protection layer 9. The panel member 7 serves as a main body of the panel 2. The intermediate layer 8 is arranged on an upper surface of the panel member 7. The protection layer 9 is arranged on an upper surface of the intermediate layer 8.

In an example, the panel member 7 is formed from a transparent resin material and has the shape of a flat plate. In the present example, the panel member 7 includes, for example, transparent rubber. The panel member 7 is elastically deformable. For example, when the panel member 7 is pushed by the user with a finger or the like, the panel member 7 is depressed in a pushing direction. When the panel member 7 is released from the pushing, the panel member 7 returns to the original state. In this manner, the flexible panel member 7 may be stretched by an external load.

The intermediate layer 8 is formed from, for example, a light-shielding material that is elastically deformable. The intermediate layer 8 has, for example, an opening 10 shaped in conformance with the mark 4. The intermediate layer 8 covers the entire panel member 7.

The protection layer 9 protects the front surface of the panel 2. The protection layer 9 is formed from, for example, fabric, leather, or the like. The protection layer 9 covers the entire panel member 7 and the entire intermediate layer 8. Preferably, the protection layer 9 is formed from, for example, a light-transmissive material.

### Casing 12

As shown in FIG. 3, the switch device 1 includes a casing 12 that supports the panel 2. The casing 12 includes, for example, a first casing 13 and a second casing 14. The first casing 13 serves as a seat for the panel 2. The second casing 14 closes the first casing 13 from below (side opposite to panel 2). The casing 12 accommodates various components of the switch device 1. That is, the casing 12 has an accommodation compartment defined by the first casing 13 and the second casing 14. Peripheral edges of the intermediate layer 8 and the protection layer 9, which cover the panel member 7, are fixed to corresponding edges of the first casing 13.

### Push-Operation Detection Structure

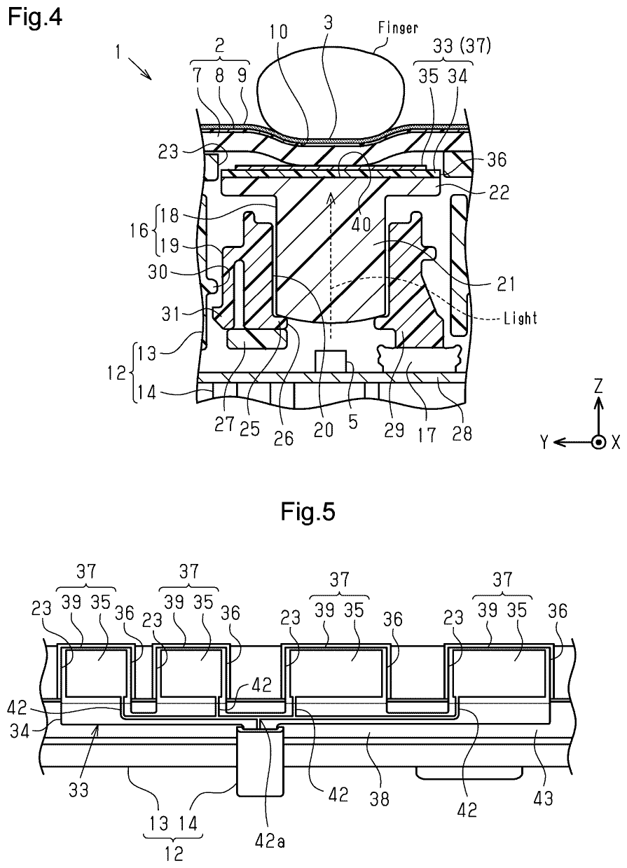

As shown in FIGS. 3 and 4, the switch device 1 includes movable members 16 and a detector 17. The movable members 16 are each moved by a push-operation performed on a corresponding one of the operating portions 3. The detector 17 detects the movement of the movable members 16 moved by the push-operation. In the present example, the switch device 1 includes pairs of the movable member 16 and the detector 17. The pairs are each assigned to a corresponding one of the operation functions. The movable members 16 are each moved by a push-operation performed on a corresponding one of the operating portions 3. The detectors 17 each detect movement of a corresponding one of the movable members 16 moved by a push-operation. The number of pairs of the movable member 16 and the detector 17 is determined in accordance with the number of operating portions 3 (i.e., operation functions) of the panel 2. The movable members 16 are accommodated in the casing 12 in a slidable manner. In the present example, the movable member 16 is accommodated in the casing 12 in a manner allowing for linear reciprocation in a height direction of the casing 12 (Z-axis direction in FIG. 3).

Each movable member 16 includes a first part 18 and a second part 19. The first part 18 is moved in a depth direction (negative Z-axis direction in FIG. 3) by a push-operation performed on a corresponding operating portion 3 by the user. The second part 19 is coupled to the first part 18. The first part 18 includes a main body 21 and an extension region 22. The main body 21 is arranged in a cavity 20 formed in the second part 19. The extension region 22 is formed on the main body 21 at a position facing the panel member 7. The extension region 22 has a greater area than the main body 21 in a planar direction (X-Y plane direction in FIG. 3). The extension region 22 is arranged in an open portion 23 formed in an upper wall of the casing 12 (in the present example, first casing 13).

The second part 19 includes a support wall 25 and an opening 26. The support wall 25 supports a lower end of the first part 18. The opening 26 exposes a back surface of the first part 18. The support wall 25 extends, for example, about a center of the second part 19 along the entire circumference. In an example, the bottom wall of the cavity 20 of the second part 19 is defined by the opening 26, which is located in the central part of the bottom wall, and the support wall 25, which projects from the side wall of the cavity 20 and extends around the opening 26. The opening 26 is formed about the axis of the second part 19. The casing 12 includes a stopper 27 arranged on an inner wall surface. When the panel 2 is pushed, the stopper 27 comes into contact with the movable member 16 to determine a stroke amount of the movable member 16 in the pushing direction.

Each detector 17 uses, for example, a microswitch. The detector 17 is mounted on a substrate 28 that is accommodated in the casing 12. When the panel 2 is pushed and slides the corresponding movable member 16 in the pushing direction, a pusher 29 at a distal end of the movable member 16 (second part 19) pushes and turns on the detector 17 (state shown in FIG. 4).

In the present example, the switch device 1 is a momentary switch that stays turned on only while the panel 2 is being pushed by the user. Specifically, when the user pushes the panel 2 and slides the movable member 16 in the pushing direction against a biasing force of a biasing member (not shown), the detector 17 stays turned on only while the detector 17 is being pushed by the movable member 16.

When the finger is removed from the panel 2, the biasing force of the biasing member (not shown) slides the movable member 16 away from the detector 17 in an opposite-pushing direction (positive Z-axis direction in FIG. 3) and returns the detector 17 to the original off state (state shown in FIG. 3). The movable member 16 (second part 19) includes an engagement piece 31 arranged on a side surface. When the movable member 16 is moved in the opposite-pushing direction, the engagement piece 31 engages a protrusion 30 arranged on an inner surface of the casing 12 so that the position of the movable member 16 is determined.

### Sensor Sheet 33

As shown in FIGS. 3 and 4, the switch device 1 includes a sensor sheet 33 that detects at least one of contact of a human body part with the panel 2, approach of a human body part toward the panel 2, and a push-operation performed on the panel 2 (operating portion 3). The sensor sheet 33 is arranged between the panel member 7 and the movable members 16. In the present example, for example, the sensor sheet 33 is arranged between a back surface of the panel member 7 and the extension region 22 of the movable members 16. Preferably, the sensor sheet 33 is fixed to, for example, the movable members 16 (extension region 22).

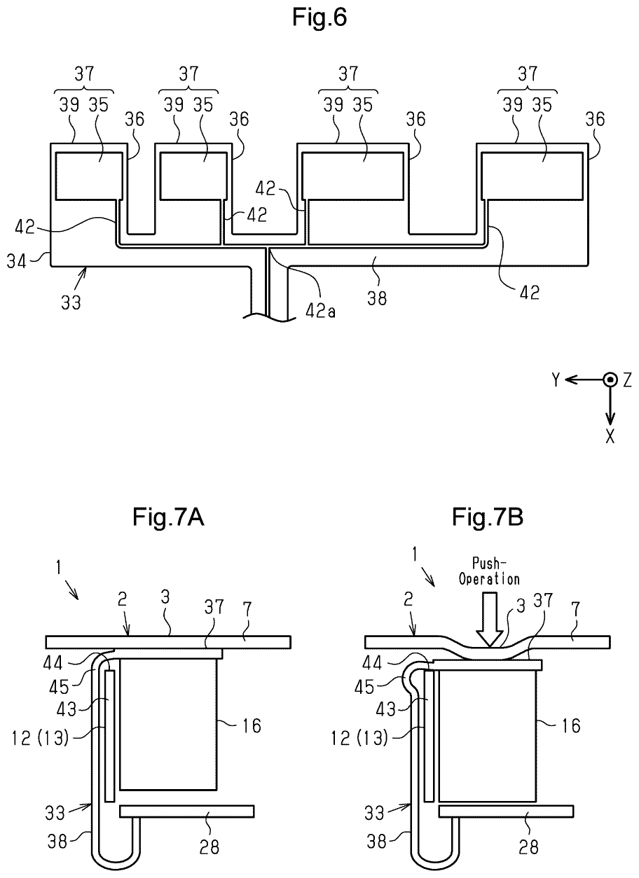

As shown in FIGS. 5 and 6, the sensor sheet 33 includes a sheet base 34 and electrodes 35. The sheet base 34 is configured to be bent and deformed. The electrodes 35 are arranged on the sheet base 34. The electrodes 35 are each arranged for a corresponding one of the operating portions 3. The sheet base 34 includes a gap 36 formed between adjacent ones of the electrodes 35. In the present example, the sheet base 34 includes gaps 36 each formed between two adjacent ones of the electrodes 35. The gap 36 is formed by, for example, a slit. The gaps 36 may differ in length as in the present example. Alternatively, the length may be identical. In the present example, the sensor sheet 33 has a comb-tooth pattern in which the gaps 36 are arranged next to one another and open in the same side of the sensor sheet 33. The sheet base 34 is formed from, for example, transparent resin.

The sensor sheet 33 includes electrode placement portions 37 and a connecting portion 38 that connects the electrode placement portions 37. Each of the electrode placement portions 37 is arranged between adjacent ones of the gaps 36 and includes a corresponding one of the electrodes 35. The electrode placement portion 37 includes a base segment 39 and the electrode 35 arranged on the base segment 39. The base segment 39 defines the shape of the electrode placement portion 37 in the sheet base 34. In the present example, the electrode 35 is arranged on part of the base segment 39, specifically, a position located toward a distal end of the base segment 39. In an example, the electrode 35 is not arranged at a position located toward a basal end of the base segment 39.

As shown in FIGS. 3 and 4, the electrode placement portions 37 are at least partially arranged on a basal end surface 40 of the movable members 16 so as to face the panel 2, which has the shape of a flat plate. (In the present example, the electrode placement portions 37 are partially arranged on the basal end surface 40 of the movable members 16.) In the present example, the basal end surface 40 is an upper end surface of the extension region 22 of a corresponding first part 18. The electrode placement portions 37 are arranged so that each of the electrode placement portions 37 is paired with a corresponding one of the operating portions 3 (movable members 16). In the present example, the sensor sheet 33 includes the electrodes 35 respectively assigned to the operating portions 3. Each electrode placement portion 37 is located between the back face of the panel member 7 and the upper end face of the extension region 22 of the corresponding first part 18.

As shown in FIG. 5, the connecting portion 38 is at least partially bent in a direction intersecting the basal end surface 40 of the movable member 16 (Z-axis direction in FIGS. 3 and 4) and is at least partially arranged at a side of the movable members 16. In the present example, the connecting portion 38 and a basal end part of each electrode placement portion 37 are located at the side of the movable members 16.

### Electrode 35

As shown in FIGS. 5 and 6, each electrode 35 is layered on the sheet base 34. For example, the electrode 35 is arranged on the front surface (or back surface) of the sheet base 34. The electrode 35 is, for example, a transparent electrode that is light-transmissive. Examples of the electrode 35 include a vapor-deposition layer formed by vaporizing an electrode material to form a film on the sheet base 34, a printed portion formed by printing an electrode material on the sheet base 34, or the like. That is, the electrode 35 is, for example, an indium tin oxide (ITO) film, a transparent ink, or the like.

As shown in FIG. 6, each electrode 35 includes a wiring part 42 electrically connected to the substrate 28. In the present example, the wiring part 42 is at least partially arranged in the connecting portion 38 (in the present example, both in electrode placement portion 37 and connecting portion 38). The wiring parts 42 of the electrodes 35 are connected into a single wiring line at a joint point 42a. In other words, the wiring parts 42 of the electrodes 35 are joined into a single wiring line at the joint point 42a. The wiring parts 42 of at least two electrodes 35 may be connected. In an example, the wiring parts 42 of the electrodes 35 may include branch wires arranged on the electrode placement portions 37 and extending from the electrodes 35, a common wire arranged on the connecting portion 38 and joined to the branch wires, and a connection wire extending from the joint point 42a of the common wire to the substrate 28. In another example, the wiring parts 42 of the electrodes 35 may include multiple sets of at least two connected wiring parts 42.

### Layout of Connecting Portion 38 of Sensor Sheet 33

As shown in FIGS. 7A and 7B, at least the connecting portion 38 (in the present example, connecting portion 38 and part of each electrode placement portion 37) is arranged along an outer surface of a wall 43 of the casing 12. In the present example, the basal end of each electrode placement portion 37 extends out of a clearance 44 between the back surface of the panel member 7 and an upper end surface of the wall 43. Further, the connecting portion 38 and the basal end of the electrode placement portion 37 are arranged along the outer surface of the wall 43 such that a distal end of the connecting portion 38 reaches the substrate 28.

### Bent Portion 45

As shown in FIGS. 7A and 7B, the sensor sheet 33 includes a bent portion 45 that bends and deforms when any of the movable members 16 is moved by pushing of the panel 2. The bent portion 45 is arranged at a part of the sensor sheet 33 (sheet base 34) extending out of the clearance 44.

### Illumination of Switch Device 1

As shown in FIGS. 3 and 4, the switch device 1 includes the light source 5 that displays the mark 4, which is provided for a corresponding one of the operating portions 3, on the panel 2 through illumination. For example, the light source 5 is a light-emitting diode (LED) and is mounted on the substrate 28. The light source 5 is arranged at a back-surface side of the panel 2. The light source 5 is, for example, positioned directly below the movable member 16 (first part 18). The light source 5 emits a light through the opening 10 of the intermediate layer 8 to the outside. This displays the shape of the opening 10 on the panel 2 as the mark 4.

In the present example, the movable member 16 is formed from, for example, resin. In particular, it is preferred that the movable member 16 (specifically, first part 18) acts as a light guide that guides the light from the light source 5 toward the mark 4. The light guide includes, for example, a transparent material, such as glass, plastic, acrylic, or the like. It is preferred that the movable member 16 (specifically, first part 18) is formed from a light-transmissive material.

### Electrical Configuration of Switch Device 1

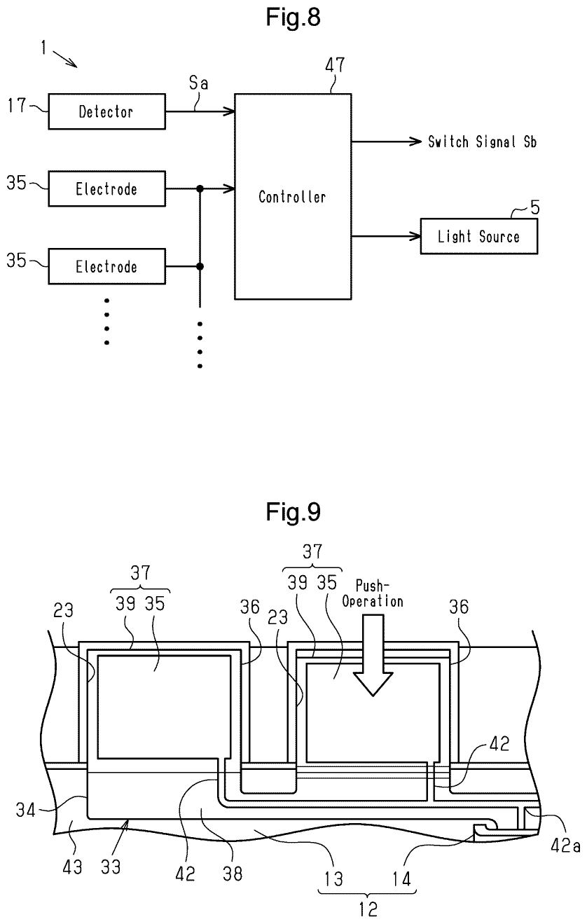

As shown in FIG. 8, the switch device 1 includes a controller 47 that controls operation of the switch device 1. The controller 47 includes, for example, a central processing unit (CPU), an electronic control unit (ECU), or the like. The detector 17 and the electrodes 35 are connected to an input to the controller 47. That is, the controller 47 receives a detection signal Sa from the detector 17 and the capacitance from each electrode 35. The movable member 16 is movable between an initial position at which the extension region 22 is located in the open portion 23 and a pushed position at which the detector 17 is pushed by the pusher 29. When the detector 17 is turned on, the controller 47 receives a detection signal Sa indicating that the detector 17 is turned on. Based on the received detection signal Sa, the controller 47 determines that the movable member 16 is located at the pushed position, or that a push-operation is performed. The light source 5 is connected to an output of the controller 47.

The controller 47 detects pushing of the operating portion 3 of the panel 2 based on the detection signal Sa received from the detector 17, and then outputs a switch signal Sb to another ECU or the like. The controller 47 detects contact of a human body part with the panel 2 or approach of a human body part toward the panel 2 based on a change in the capacitance of the electrode 35. In the present example, when the controller 47 detects that a human body part came into contact with the panel 2 or approached toward the panel 2 based on a change in the capacitance of the electrode 35, the controller 47 illuminates the mark 4 on the panel 2 by lighting the light source 5. This allows the user to immediately recognize the corresponding relationship of the operation function and the operating portion 3 on the panel 2.

### Operation of the Present Embodiment

The operation of the switch device 1 in accordance with the present embodiment will now be described.

As shown in FIG. 9, the sensor sheet 33 includes the gaps 36 formed between adjacent ones of the electrodes 35. This allows each electrode placement portion 37 to deform independently in accordance with the corresponding electrode 35. Therefore, when a predetermined operating portion 3 of the panel 2 is pushed, only the electrode placement portion 37 of the sensor sheet 33 located directly below the pushed operating portion 3 is moved downward. In other words, the entire sensor sheet 33 will not be depressed around the pushed point of the operating portion 3. This minimizes the stretching load applied to the sensor sheet 33, thereby avoiding breakage of the sensor sheet 33.

Further, the wiring parts 42 of the electrodes 35 are electrically connected to each other. Accordingly, even if a plurality of relatively small electrodes 35 is provided for each movable member 16, the electrodes 35 can be used as one electrode 35 having a relatively large area. This improves the detection sensitivity of the electrode 35. As a result, breakage of the sensor sheet 33 is avoided while the touch-operation detection sensitivity is improved.

### Advantages of the Embodiment

The switch device 1 of the above embodiment has the following advantages.

(1) The switch device 1 includes the elastically deformable panel 2, the movable members 16, the detector 17, and the sensor sheet 33. The panel 2 includes the operating portions 3 each configured to receive a push-operation. The movable members 16 are each configured to be moved by the push-operation performed on the panel 2. The detector 17 is configured to detect the movement of the movable members 16. The sensor sheet 33 detects at least one of contact of a human body part with the panel 2, approach of a human body part toward the panel 2, and a push-operation performed on the panel 2 (operating portion 3). The sensor sheet 33 includes the sheet base 34 and the electrodes 35. The sheet base 34 is configured to be bent and deformed. The electrodes 35 are each arranged on the sheet base 34 for a corresponding one of the operating portions 3. The sheet base 34 includes the gaps 36 each formed between adjacent ones of the electrodes 35. At least two of the wiring parts 42 of the electrodes 35 are connected to one another.

With this structure, the sheet base 34 of the sensor sheet 33 includes the gaps 36 that divide the sheet base 34 into electrode units. Therefore, when any one of the operating portions 3 of the panel 2 is pushed, only a sheet portion of the electrode 35 corresponding to the pushed operating portion 3 independently moves in the pushing direction. In other words, the entire sensor sheet 33 will not be depressed around the electrode 35 moving in the pushing direction. This minimizes the stretching load locally applied to the sensor sheet 33, thereby avoiding breakage of the sensor sheet 33.

In addition, the electrodes 35 are electrically connected through wire connection, so that the connected electrodes 35 can be used as one electrode 35 having a relatively large area. Thus, a touch-operation performed on the panel 2 may be detected with a relatively high sensitivity. As a result, breakage of the sensor sheet 33 is avoided while the touch-operation detection sensitivity is improved.

(2) The sensor sheet 33 includes the electrode placement portions 37 and the connecting portion 38. Each of the electrode placement portions 37 is arranged between adjacent ones of the gaps 36 and includes a corresponding one of the electrodes 35. The connecting portion 38 connects the electrode placement portions 37. The electrode placement portions 37 are at least partially arranged on the basal end surface 40 of the movable members 16 so as to face the panel 2, which has the shape of a flat plate. The connecting portion 38 is at least partially bent in a direction intersecting the basal end surface 40 of the movable members 16 and is at least partially arranged at a side of the movable members 16. The wiring part 42 is at least partially arranged on the connecting portion 38. With this structure, the sensor sheet 33 is bent and extends along the shape of the movable members 16. Thus, the sensor sheet 33 uses a relatively small space.

(3) The switch device 1 includes the casing 12 that supports the panel 2 and accommodates the movable members 16 in a slidable manner. At least the connecting portion 38 is arranged along the outer surface of the wall 43 of the casing 12. With this structure, even if there is not enough space for accommodating the sensor sheet 33 between the casing 12 and the movable members 16, the connecting portion 38 of the sensor sheet 33 may be arranged outside the wall 43 of the casing 12.

(4) The sensor sheet 33 includes the bent portion 45 that bends and deforms when any of the movable members 16 is moved by a push-operation performed on the panel 2. With this structure, when any one of the operating portions 3 of the panel 2 is pushed and the corresponding movable member 16 is moved, the bent portion 45 of the sensor sheet 33 absorbs the bending stress generated in the sensor sheet 33. Therefore, an excess stress will not be applied to a certain part of the sensor sheet 33. This further avoids breakage of the sensor sheet 33.

(5) The sensor sheet 33 has a comb-tooth pattern in which the gaps 36 are arranged next to one another and open in the same side of the sensor sheet 33. With this configuration, when the wiring parts 42 of the electrodes 35 are connected, the connected wiring parts 42 of the electrodes 35 may extend in the same direction. This simplifies the structure and shape of the sensor sheet 33.

(6) The switch device 1 includes the light source 5 that displays the mark 4, which is provided for a corresponding one of the operating portions 3, on the panel 2 through illumination. With this structure, the mark 4 allows for visual recognition of the operation function corresponding to the operating portion 3. This improves operation convenience for the user.

(7) The movable members 16 each act as a light guide that guides the light from the light source 5 toward the panel 2. With this structure, the movable member 16 also acts as a light guide. This reduces the number of components as compared with when the light guide is a separate component.

### Other Embodiments

The above embodiment may be modified as follows. The above embodiment and the following modifications can be combined as long as they remain technically consistent with each other.

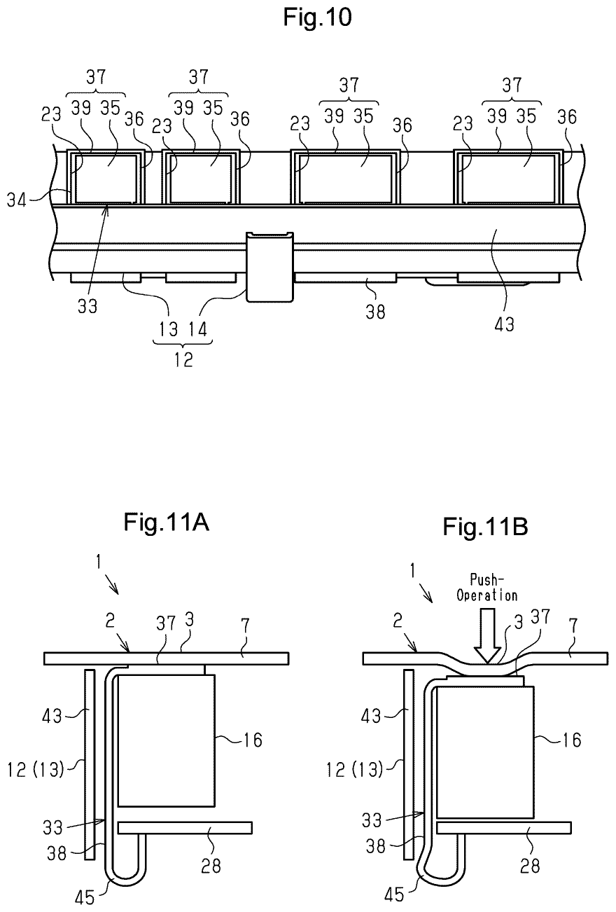

As shown in FIGS. 10, 11A, and 11B, when there is a predetermined gap between the wall 43 of the casing 12 (refer to FIG. 11) and the movable members 16, the sensor sheet 33 (specifically, connecting portion 38) may be partially arranged in this gap. This utilizes the gap between the wall 43 of the casing 12 and the movable members 16 effectively. Further, as shown in FIGS. 11A and 11B, the bent portion 45 may be formed at a part extending out from the lower end of the wall 43.

The gaps 36 do not have to be arranged next to one another and open in the same side of the sheet base 34. Alternatively, the gaps 36 may be alternately arranged and open in the two opposite sides of the sheet base 34.

The electrode placement portions 37 do not have to be located only at positions corresponding to the movable members 16. For example, the electrode placement portions 37 may also be arranged at positions corresponding to the gaps 36. This increases the electrode area, thereby further improving the touch-operation detection sensitivity.

When the panel 2 is not pushed, there may be no gap between the panel 2 (panel member 7) and the sensor sheet 33. Alternatively, there may be a gap between the panel 2 (panel member 7) and the sensor sheet 33.

The panel 2 does not have to cover the plurality of movable members 16. For example, the panel 2 may be provided for each of the movable members 16.

The material of the panel 2 may include a polyethylene terephthalate (PET) sheet or silicon.

The movable member 16 does not have to include multiple parts and may be formed by a single part.

The wiring parts 42 may be connected to one another at any position.

Each electrode placement portion 37 may be entirely arranged on the basal end surface 40 of the movable member 16.

The connecting portion 38 may be partially arranged on the basal end surface 40 of the movable member 16.

The connecting portion 38 does not have to be bent perpendicularly with respect to the electrode placement portions 37. Instead, the connecting portion 38 may be bent at an angle other than a right angle. For example, the connecting portion 38 may be bent diagonally with respect to the electrode placement portions 37.

The sheet base 34 does not have to be shaped as shown in the above embodiment.

The intermediate layer 8 having the shape in conformance with the mark 4 may be arranged on the back surface of the panel member 7.

The mark 4 may be displayed on the panel 2 as an image or a video using liquid crystals.

The mark 4 may be always visually recognizable. For example, the mark 4 may be illuminated with the light of the light source 5 at night.

The light guide may be a member differing from the movable member 16.

The intermediate layer 8 and/or the protection layer 9 may be omitted from the panel 2.

The detector 17 does not have to be a mechanical switch and may be a sensor.

The momentary structure of the switch device 1 does not have to use a biasing force of a spring to return to the initial position, and may use, for example, an elastic force of rubber or the like.

The sensor sheet 33 does not have to include the electrodes 35 arrayed in a single row. The electrodes 35 may be arrayed in two or more rows.

The apparatus operated by the switch device 1 is not limited to an air conditioner, and may be, for example, a car navigation device, an audio device, a lighting device, or the like.

The present disclosure described in accordance with embodiments is to be considered as illustrative and not restrictive. The present disclosure includes various modified examples and modifications within the scope of equivalence. Additionally, various combinations and modes and one, more, or less of these elements in other combinations and forms are included in the range and conceptual scope of the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A switch device, comprising:
an elastically deformable panel including operating portions, each of the operating portions being configured to receive a push-operation and assigned to a corresponding one of operation functions;
movable members each configured to be moved by the push-operation performed on a corresponding one of the operating portions;
a detector configured to detect movement of the movable members moved by the push-operation; and
a sensor sheet arranged between the panel and the movable members to detect at least one of contact of a human body part with the panel, approach of a human body part toward the panel, and the push-operation performed on the panel, wherein:
the sensor sheet includes a sheet base configured to be bent and deformed, and electrodes each arranged on the base sheet for a corresponding one of the operating portions;
the sheet base includes a gap formed between adjacent ones of the electrodes; and
the electrodes each include a wiring part, and wiring parts of at least two of the electrodes are connected to one another other.

2. The switch device according to claim 1, wherein:
the gap is one of multiple gaps, and the gaps are each formed between two adjacent ones of the electrodes;
the sensor sheet includes electrode placement portions, each arranged between two adjacent ones of the gaps and including a corresponding one of the electrodes, and a connecting portion that connects the electrode placement portions;
the electrode placement portions are at least partially arranged on a basal end surface of the movable members so as to face the panel, the panel having a shape of a flat plate;
the connecting portion is at least partially bent in a direction intersecting the basal end surface of the movable members and at least partially arranged on a side of the movable members; and
the wiring part is at least partially arranged on the connecting portion.

3. The switch device according to claim 2, further comprising:
a casing that supports the panel and accommodates the movable members in a slidable manner,
wherein at least the connecting portion is arranged along an outer surface of a wall of the casing.

4. The switch device according to claim 1, wherein the sensor sheet includes a bent portion that bends and deforms when any of the movable members is moved by the push-operation performed on the panel.

5. The switch device according to claim 1, wherein:
the gap is one of multiple gaps, and the gaps are each formed between two adjacent ones of the electrodes; and
the sensor sheet has a comb-tooth pattern in which the gaps are arranged next to one another and open in a same side of the sensor sheet.

6. The switch device according to claim 1, further comprising a light source that displays a mark on the panel through illumination, the mark provided for a corresponding one of the operating portions.

7. The switch device according to claim 6, wherein the movable members each act as a light guide that guides a light from the light source toward the panel.
